(19) United States
(12) Patent Application Publication
(10) Pub. No.: US 2026/0365347 A1
(43) Pub. Date: Nov. 19, 2026

(54) Carrier Platform for Selective Deployment and Control of Multiple Aerial Vehicles in Electronic Warfare Environments

(71) Applicant: Ruslan Prysiazhnyi, Orlando, FL (US)

(72) Inventor: Ruslan Prysiazhnyi, Orlando, FL (US)

(21) Appl. No.: 19/686,945

(22) Filed: May 25, 2026

Related U.S. Application Data
(63) Continuation of application No. 19/206,747, filed on May 13, 2025.

(51) Int. Cl. B64U 80/82; B64U 10/60; B64U 70/20; B64U 80/30; B64U 101/18

(52) U.S. Cl. CPC B64U 80/82; B64U 10/60; B64U 70/20; B64U 80/30; B64U 2101/18; B64U 2201/20

(57) ABSTRACT

A carrier unmanned aerial vehicle system for operation in an electronic warfare environment transports a plurality of deployable aerial vehicles in an internal compartment, external compartment, or open platform of a carrier unmanned aerial vehicle. The carrier selectively releases one or more of the deployable aerial vehicles during flight while maintaining individualized communication links for control and feedback. A deployment mechanism coordinates release, and a disconnection mechanism selectively disconnects a respective communication link upon completion of a mission parameter. The carrier may continue a mission with remaining deployable aerial vehicles and return to base after a release sequence.

### CROSS-REFERENCE TO RELATED APPLICATIONS

This application is a continuation of U.S. application Ser. No. 19/206,747, filed May 13, 2025, which claims the benefit of U.S. Provisional Application No. 63/650,933, filed May 23, 2024. The entire disclosures of the foregoing applications are incorporated herein by reference in their entireties.

### FIELD OF THE INVENTION

The present invention relates generally to unmanned aerial vehicle systems and, more particularly, to carrier platforms configured for selective deployment and control of multiple deployable aerial vehicles in electronic warfare environments.

### BACKGROUND OF THE INVENTION

Electronic warfare environments create substantial challenges for conventional unmanned aerial vehicle systems due to radio-frequency jamming, communication interference, and limited survivability of remotely controlled aerial vehicles.

Existing drone deployment systems are often limited in their ability to maintain reliable communication with deployable aerial vehicles after release from a carrier platform. In addition, conventional systems may lack flexible deployment architectures capable of selectively releasing multiple aerial vehicles during a mission while maintaining individual communication and control.

Accordingly, there exists a need for improved carrier unmanned aerial vehicle systems capable of transporting, selectively deploying, and controlling multiple deployable aerial vehicles in contested electronic warfare environments.

### SUMMARY OF THE INVENTION

The present invention provides carrier unmanned aerial vehicle systems configured to transport and selectively deploy multiple deployable aerial vehicles during operation in electronic warfare environments.

In certain embodiments, a carrier unmanned aerial vehicle transports multiple deployable aerial vehicles within an internal compartment, external compartment, or open platform arrangement. Individual communication links are associated with respective deployable aerial vehicles to permit communication and control after deployment.

A deployment mechanism selectively releases one or more deployable aerial vehicles while maintaining communication with the deployed vehicles. A disconnection mechanism may selectively disconnect a communication link upon completion of a mission parameter.

In certain embodiments, the communication links comprise optical fiber communication links.

Additional embodiments relate to methods of operating carrier unmanned aerial vehicle systems and mission control systems configured for coordinated deployment of multiple deployable aerial vehicles.

### BRIEF DESCRIPTION OF THE DRAWINGS

FIG. 1 illustrates a carrier unmanned aerial vehicle configured to transport multiple deployable aerial vehicles.

FIG. 2 illustrates selective deployment of deployable aerial vehicles from the carrier unmanned aerial vehicle during operation.

FIG. 3 illustrates a deployable aerial vehicle connected through a communication link after deployment from the carrier unmanned aerial vehicle.

### DETAILED DESCRIPTION OF THE INVENTION

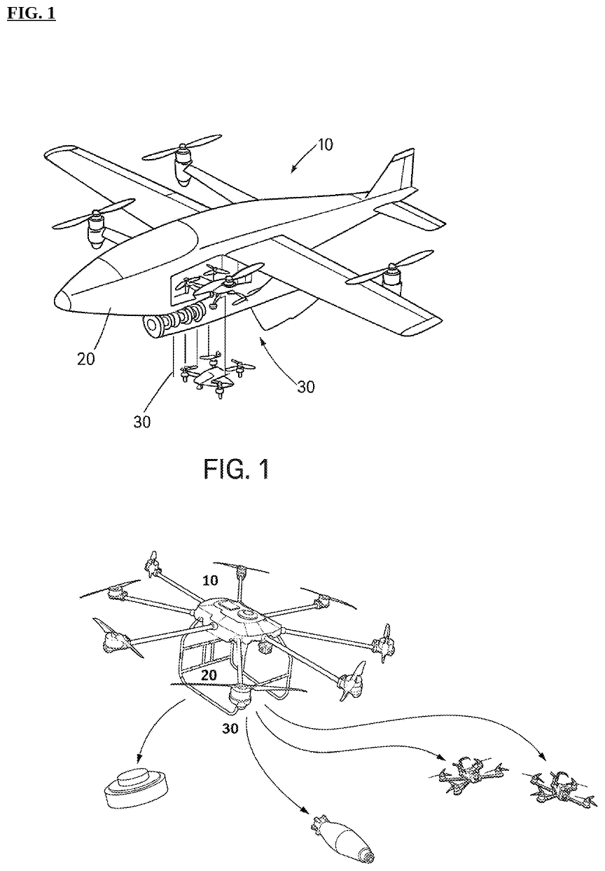

Referring to FIG. 1, a carrier unmanned aerial vehicle 10 includes at least one internal storage compartment, external storage compartment, or open platform 20 configured to transport multiple deployable aerial vehicles.

The deployable aerial vehicles may be selectively released during operation through one or more deployment ports 30 positioned beneath or adjacent to the carrier unmanned aerial vehicle.

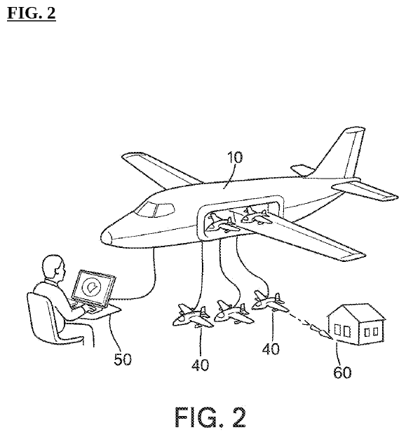

Referring to FIG. 2, deployable aerial vehicles 40 may be released sequentially or selectively during operation while communication and control are maintained through respective communication links. An operator station 50 may communicate with the carrier unmanned aerial vehicle and deployed aerial vehicles during a mission directed toward a target structure 60.

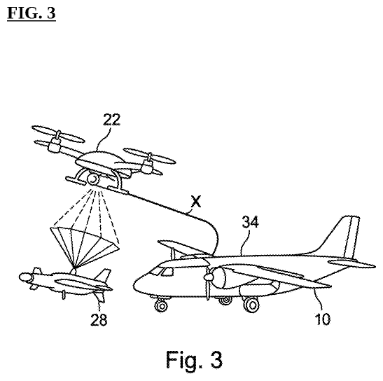

Referring to FIG. 3, a deployable aerial vehicle 22 may remain connected to the carrier unmanned aerial vehicle 10 through a communication link 34 after deployment. In certain embodiments, the communication link comprises an optical fiber communication line. A deployable aerial vehicle may carry a payload or munition 28 configured for operation during a mission.

The carrier unmanned aerial vehicle may continue operation after release of one or more deployable aerial vehicles and may return to a ground base with one or more remaining deployable aerial vehicles after completion of a mission sequence.

1. A carrier unmanned aerial vehicle system for operation in an electronic warfare environment, comprising: a carrier unmanned aerial vehicle having a body and at least one of an internal storage compartment, an external storage compartment, or an open platform configured to transport a plurality of deployable aerial vehicles; a plurality of deployable aerial vehicles removably supported by the at least one of the internal storage compartment, the external storage compartment, or the open platform; a plurality of communication links, each communication link being associated with a respective one of the plurality of deployable aerial vehicles and extending from the carrier unmanned aerial vehicle for control of the respective deployable aerial vehicle after deployment; a deployment mechanism mounted on the carrier unmanned aerial vehicle and configured to selectively release one or more of the plurality of deployable aerial vehicles while the respective communication link remains connected; and a disconnection mechanism configured to selectively disconnect a selected one of the communication links upon completion of a predetermined mission parameter.

2. The system of claim 1, wherein each of the communication links comprises an optical fiber.

3. The system of claim 1, wherein the plurality of deployable aerial vehicles comprises attack drones.

4. The system of claim 1, wherein the plurality of deployable aerial vehicles comprises reconnaissance drones.

5. The system of claim 1, wherein the carrier unmanned aerial vehicle is configured to communicate with an operator via fiber-optic communication or radio communication.

6. The system of claim 1, wherein the deployment mechanism is configured to release the one or more deployable aerial vehicles while the carrier unmanned aerial vehicle is in flight.

7. The system of claim 1, wherein the one or more deployable aerial vehicles remain controllable through the respective communication links during navigation toward a target area.

8. The system of claim 1, wherein the deployment mechanism is configured to release the deployable aerial vehicles sequentially.

9. The system of claim 1, wherein the at least one of the internal storage compartment, the external storage compartment, or the open platform is located beneath the body of the carrier unmanned aerial vehicle.

10. A method of operating a carrier unmanned aerial vehicle system in an electronic warfare environment, comprising: transporting a plurality of deployable aerial vehicles on a carrier unmanned aerial vehicle; selectively releasing at least one deployable aerial vehicle from at least one of an internal storage compartment, an external storage compartment, or an open platform of the carrier unmanned aerial vehicle while maintaining a communication link between the carrier unmanned aerial vehicle and the deployable aerial vehicle; transmitting control signals through the communication link to the deployable aerial vehicle during navigation toward a target area; and selectively disconnecting the communication link after completion of a predetermined mission parameter.

11. The method of claim 10, wherein transmitting control signals comprises transmitting guidance information and receiving feedback information through the communication link.

12. The method of claim 10, wherein the carrier unmanned aerial vehicle communicates with an operator through a radio communication link while the deployable aerial vehicle communicates with the carrier unmanned aerial vehicle through an optical fiber.

13. The method of claim 10, further comprising, after a first mission attempt is unsuccessful, selectively releasing another deployable aerial vehicle from the carrier unmanned aerial vehicle.

14. The method of claim 10, further comprising returning the carrier unmanned aerial vehicle with at least one remaining deployable aerial vehicle to a ground base after disconnecting the communication link.

15. The method of claim 10, wherein the deployable aerial vehicle is launched downwardly from the carrier unmanned aerial vehicle.

16. A mission control system for a carrier unmanned aerial vehicle configured to transport a plurality of deployable aerial vehicles, the mission control system comprising: a deployment controller configured to command selective release of one or more of the plurality of deployable aerial vehicles from the carrier unmanned aerial vehicle; a communication interface configured to maintain control of each released deployable aerial vehicle through a respective communication link; and a disconnection controller configured to command selective post-engagement disconnection of a selected communication link upon completion of a predetermined mission parameter.

17. The mission control system of claim 16, wherein the deployment controller is configured to control release of more than one deployable aerial vehicle during a single mission.

18. The mission control system of claim 16, wherein the communication interface is configured to route respective communication links through ports positioned beneath the carrier unmanned aerial vehicle.

19. The mission control system of claim 16, wherein the carrier unmanned aerial vehicle is a multirotor vehicle having six propellers or eight propellers.
